(19) United States
(12) Patent Application Publication
(10) Pub. No.: US 2026/0110522 A1
(43) Pub. Date: Apr. 23, 2026

(54) REMOTELY RESETTABLE SPORTS TARGET SYSTEM

(71) Applicants: Joseph Edward Bell, III, Easton, PA (US); Anthony John Garcia, Port Jefferson, NY (US)

(72) Inventors: Joseph Edward Bell, III, Easton, PA (US); Anthony John Garcia, Port Jefferson, NY (US)

(21) Appl. No.: 19/426,981

(22) Filed: Dec. 19, 2025

Related U.S. Application Data
(63) Continuation-in-part of application No. 18/064,881, filed on Dec. 12, 2022, now Pat. No. 12,523,454.

(51) Int. Cl. F41J 7/04; H01F 7/02

(52) U.S. Cl. CPC F41J 7/04; H01F 7/0252

(57) ABSTRACT

A sports target system includes a case defining a longitudinal axis; at least one target subsystem secured to the case, each target subsystem of the at least one target subsystem including a mount secured to the case, a target holder, and a crank, the target holder and the crank each being rotatably secured to the mount, wherein the target holder is rotatable between an upright position and a horizontal position; and an actuator secured to the base and configured to translate a push bar subsystem; wherein when the actuator translates the push bar subsystem, the push bar subsystem is configured to engage each crank of the at least one target subsystem and cause rotation thereof, and for each target subsystem, rotation of the crank is configured to rotate the target holder from the horizontal position to the upright position.

### STATEMENT OF RELATED APPLICATION(S)

This application is a continuation-in-part of U.S. patent application Ser. No. 18/064,881 filed on Dec. 12, 2022, entitled “Remote Resetting Sports Target”, the disclosure of which is hereby incorporated by reference herein in its entirety.

### TECHNICAL FIELD

The present invention is directed to shooting sports and targets therefore designed to be struck by projectiles, specifically for targets configured to be reset remotely.

### BACKGROUND

There are many sports targets that exist which allow an individual to practice or compete. While there are various categories of targets, one main category is stationary targets. In some instances, these targets are made from paper. In many cases, paper targets have the primary drawback of not being able to see the precise hit locations without some sort of optic device. Further, depending on the type of projectile, some items may not be able to pierce cardboard backed paper. Without cardboard, paper targets are flimsy or cannot be secured in an upright manner.

One solution to paper targets are upright targets made from a material that will issue a percussion sound when struck. These targets also have several flaws. One is that these targets must allow certain projectiles to pass through them for safety reasons. A projectile that does not pass through may not strike with enough force to create a sound. Further, for precision or competition shooting sports the exact location of a hit may be necessary. With gong targets this may not be possible. It may not be possible to determine when a specific target is struck using these targets.

One solution to this problem is to allow for the targets that are struck to rotate into a downed position. This still leaves much to be desired. First, one issue with knockdown targets is that wind may be able to knock the target down. This means that targets may fall that have not been hit. Another issue is the need to reset targets. In the current art, a person needs to reset the target manually.

One method to reset the targets is to walk down range and place the targets in an upright position. This could result in walking significant distances. Another method of resetting targets is to hit a special trigger target. In these scenarios a person will have to use a projectile to hit a special reset target, and the primary targets will return to the upright position. This has two flaws. First, a person may accidentally hit the reset target prematurely causing the targets to unwantedly reset. Second, as the primary goal is practice, a less skilled shooter may find it difficult to hit the reset target. This may result in having to reset the target manually in any case.

One solution to reset targets, which eliminates the need for a walk, is a pull sting. However, this is extremely limited. Targets of a certain weight will be difficult to reset via a string or rope. Further, ropes will be capped at certain distances. This will limit shooters to practicing at short distances in order to ensure the rope reset will still properly function.

The remote resetting sports target not only allows for a user to reset their target from a distance but also adds several components of safety to the shooting sports world. While many precautions are taken at ranges there is still always potential for accidents. Many of these Accidents occur when individuals go to reset or check their targets. By using the remote resetting sports target an individual will not have to move down range. This ensures that less accidents amongst the shooting sports community will occur.

Therefore, a need exists for a sports target that is usable with a wide variety of projectile types and also may be reset remotely without the need for manual intervention.

### SUMMARY

An object of the present invention according to a first embodiment of the present invention includes a sports target system includes a case defining a longitudinal axis; at least one target subsystem secured to the case, each target subsystem of the at least one target subsystem including a mount secured to the case, a target holder, and a crank, the target holder and the crank each being rotatably secured to the mount, wherein the target holder is rotatable between an upright position and a horizontal position; and an actuator secured to the base and configured to translate a push bar subsystem; wherein when the actuator translates the push bar subsystem, the push bar subsystem is configured to engage each crank of the at least one target subsystem and cause rotation thereof, and for each target subsystem, rotation of the crank is configured to rotate the target holder from the horizontal position to the upright position.

Another object of the present invention includes the at least one target subsystem includes six target subsystems.

Another object of the present invention includes the case includes a lower case section and an upper case section, the lower case section and the upper case section being orthogonal.

Another object of the present invention includes each crank of the at least one target subsystem is configured to rotate in a plane parallel to the lower case section.

Another object of the present invention includes an axis of rotation of each crank is orthogonal to the longitudinal axis.

Another object of the present invention includes the target holder further includes at least one lever arm configured to engage the crank.

Another object of the present invention includes the crank further includes at least one target holder engagement arm configured to engage the at least one lever arm.

Another object of the present invention includes the target holder further includes one or more magnets in a magnet holder, and the mount further includes one or more magnets, and the one or more magnets of the target holder are configured to engage the one or more magnets of the mount when the target holder is in the upright position.

Another object of the present invention includes the push bar subsystem further includes a push rod and at least one push block.

Another object of the present invention includes a number of push blocks in the at least one push block is equal to the number of target subsystems in the at least one target subsystem.

Another object of the present invention includes the at least one push block includes six push blocks.

An object of the present invention according to a second embodiment of the present invention includes a sports target system including a case defining a longitudinal axis and including a lower case section and an upper case section, the lower case section and the upper case section being orthogonal; at least one target subsystem secured to the case, each target subsystem of the at least one target subsystem including a mount secured to the case, a holder arm assembly, and a crank, the holder arm assembly and the crank each being rotatably secured to the mount, wherein the holder arm assembly is rotatable between an upright position and a horizontal position; and an actuator secured to the base and configured to translate a push bar subsystem; wherein the holder arm assembly includes a holder body rotatably secured to the mount, a lower linkage extending from the holder body, an upper linkage hingedly secured to the lower linkage at a first end and hingedly secured to a target plate at a second end, and the target plate hingedly secured to the upper case section, when the actuator translates the push bar subsystem, the push bar subsystem is configured to engage each crank of the at least one target subsystem and cause rotation thereof, and for each target subsystem, rotation of the crank is configured to rotate the target holder from the horizontal position to the upright position.

In another aspect, any one or more aspects or features described herein may be combined with any one or more other aspects or features for additional advantage.

Other aspects and embodiments will be apparent from the detailed description and accompanying drawings.

Those skilled in the art will appreciate the scope of the present disclosure and realize additional aspects thereof after reading the following detailed description of the preferred embodiments in association with the accompanying drawing figures.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1A is a front perspective view of a sports target system according to a first embodiment of the present invention.

FIG. 1B is a rear perspective view of the sports target system of FIG. 1A.

FIG. 2A is a partial front perspective section view of the sports target system of FIG. 1A.

FIG. 2B is a partial front perspective section view of the sports target system of FIG. 1A, shown in an alternate configuration.

FIG. 3 is a perspective view of a target subsystem of the sports target system of FIG. 1A, shown in the upright position.

FIG. 4 is a perspective view of the target subsystem of the sports target system of FIG. 1B, shown in the horizontal position.

FIG. 5 is an exploded view of the target subsystem of FIG. 3.

FIG. 6 is a target plate holder of the target subsystem of FIG. 3.

FIG. 7A is a front perspective view of a sports target system according to a second embodiment of the present invention.

FIG. 7B is a front perspective section view of the sports target system of FIG. 7A.

FIG. 8 is a rear perspective view of a target subsystem of the sports target system of FIG. 7A.

FIG. 9A is a left side elevation section view of a holder arm assembly of the target subsystem of FIG. 8, shown in the horizontal position.

FIG. 9B is a left side elevation section view of a holder arm assembly of the target subsystem of FIG. 8, shown in an intermediate position.

FIG. 9C is a left side elevation section view of a holder arm assembly of the target subsystem of FIG. 8, shown in the upright position.

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element such as a layer, region, or substrate is referred to as being “on” or extending “onto” another element, it can be directly on or extend directly onto the other element or intervening elements may also be present. In contrast, when an element is referred to as being “directly on” or extending “directly onto” another element, there are no intervening elements present. Likewise, it will be understood that when an element such as a layer, region, or substrate is referred to as being “over” or extending “over” another element, it can be directly over or extend directly over the other element or intervening elements may also be present. In contrast, when an element is referred to as being “directly over” or extending “directly over” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

Relative terms such as “below” or “above” or “upper” or “lower” or “horizontal” or “vertical” may be used herein to describe a relationship of one element, layer, or region to another element, layer, or region as illustrated in the Figures. It will be understood that these terms and those discussed above are intended to encompass different orientations of the device in addition to the orientation depicted in the Figures.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

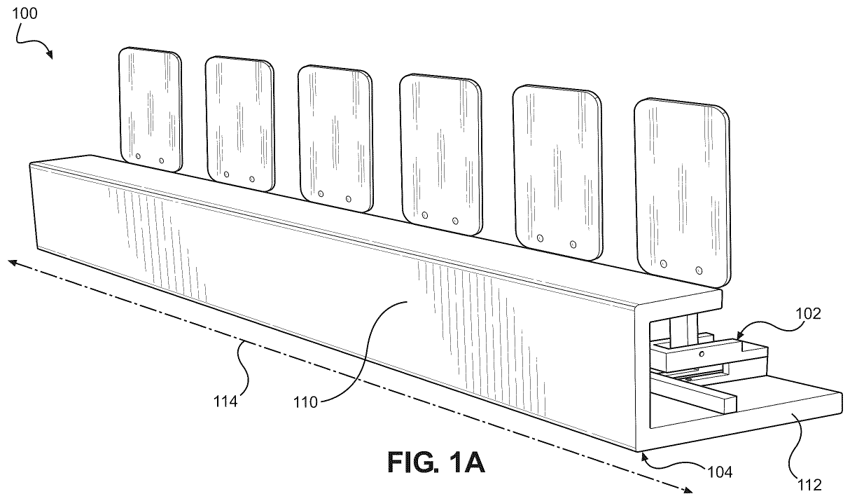

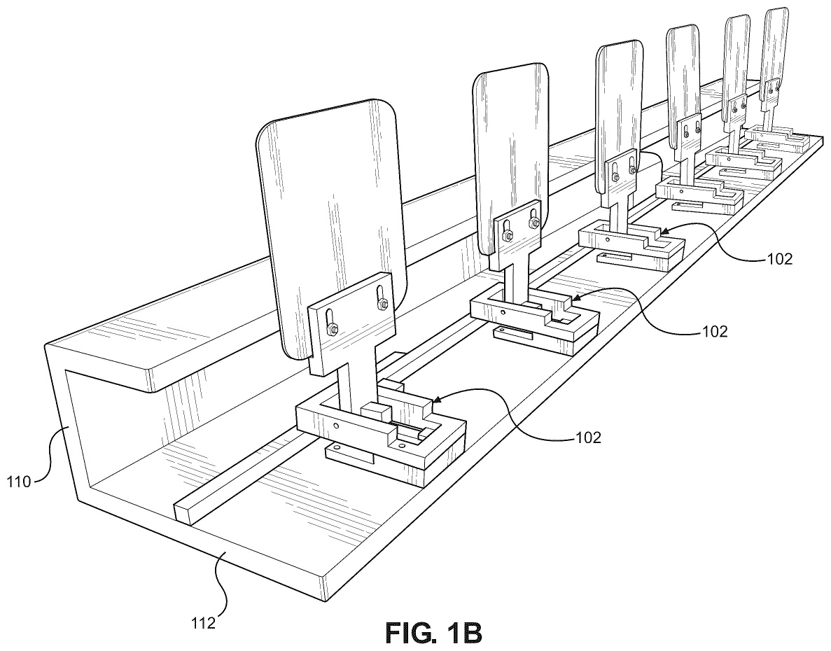

Referring now to FIGS. 1A-1B, a sports target system 100 according to a first embodiment of the present invention is illustrated. The sports target system 100 comprises at least one target subsystem 102 secured to a case 104, an actuator 106 secured to the case 104, and a push bar subsystem 108 connected to the actuator 106 and the at least one target subsystem 102.

The case 104 comprises a front case section 110 and a base case section 112. In an exemplary embodiment, the front case section 110 and the base case section 112 are integrally and monolithically connected. In another exemplary embodiment, the front case section 110 and the base case section 112 are separate elements that are joined together via fastening means. The case 104 may comprise a wood material, a metal material, a plastic material, and/or any other suitable structural material. In an exemplary embodiment, the material of the case 104 is selected based on the type of projectile to be used with the sports target system 100. For example, when the projectile to be utilized is a plastic pellet from an airsoft weapon, the case 104 may comprise plastic. In another example, when the projectile to be utilized is a bullet from a firearm, the case 104 may comprise steel or other metal material. In an exemplary embodiment, the case 104 is configured to have an aspect ratio of length to width greater than 1, greater than 2, greater than 3, or greater than n. In an exemplary embodiment, the case 104 defines a longitudinal axis 114 parallel to the length of the front case section 110 and/or the base case section 112.

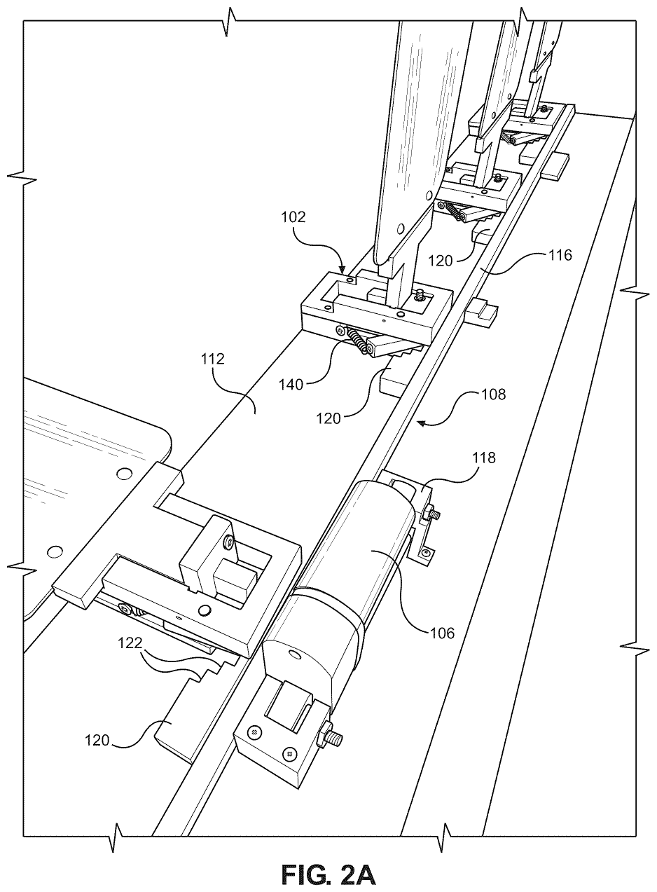

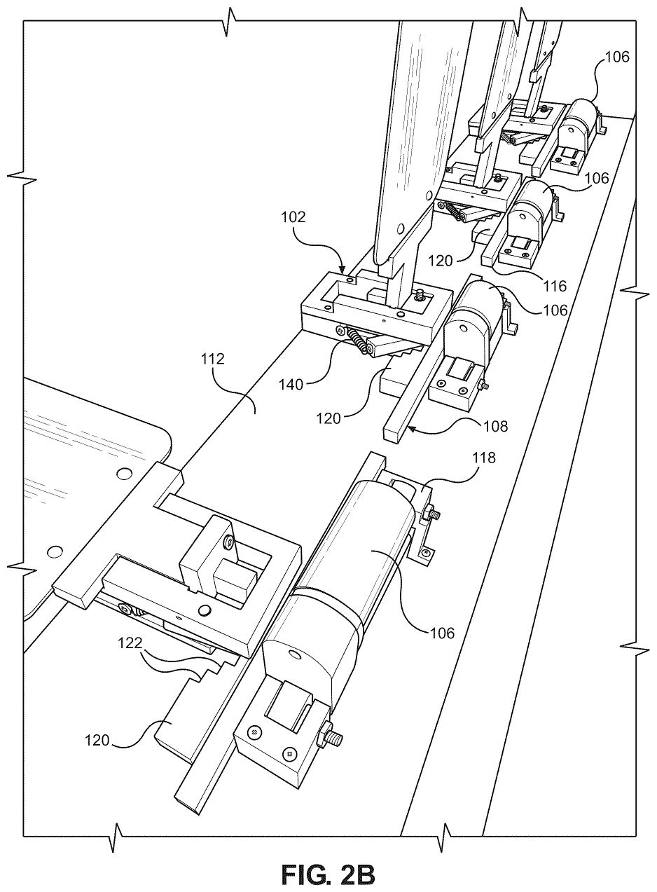

Referring now to FIG. 2A, the sports target system 100 further comprises the actuator 106 and the push bar subsystem 108. In an exemplary embodiment, the actuator 106 is secured to a top surface of the base case section 112. In an exemplary embodiment, the actuator 108 is configured as an electric actuator, an electromechanical actuator, a hydraulic actuator, a pneumatic actuator, a piezoelectric actuator, and/or any other suitable actuator type. In an exemplary embodiment, the actuator 106 is mounted to the case 104 such that a direction of actuation is substantially parallel to the longitudinal axis 114. In an exemplary embodiment, the actuator 106 is secured to the push bar subsystem 108, such that extension and contraction of the actuator 106 translates the push bar subsystem 108 along the longitudinal axis 114. In an exemplary embodiment, the actuator 106 is configured to be activated wirelessly through a remote control or to be activated by a wired controller.

In an exemplary embodiment, the push bar subsystem 108 comprises a push rod 116, an actuator connector 118 connecting the push rod 116 to the actuator 106, and at least one push block 120. In an exemplary embodiment, the actuator connector 118 is reversibly secured to the actuator 108 and fixedly secured to the push rod 116. The at least one push block 120 is configured to be fixedly secured to the push rod 116, such that translation of the push rod 116 by extension of the actuator 106 engages the at least one push block 120 with the at least one target subsystem 102. In an exemplary embodiment, the at least one push block 120 is secured to a side of the push rod 116 opposite to a side on which the actuator connector 118 is located. In an exemplary embodiment, a number of push blocks 120 in the at least one push block 120 is equal to the number of target subsystems 102 in the at least one target subsystem 102. In a preferred embodiment, the number of push blocks 120 is six. In an exemplary embodiment, the at least one push block 120 comprises steps 122 configured to engage the at least one target subsystem 102.

Referring now to FIG. 2B, an alternative configuration of the sports target system 100 is illustrated. In an exemplary embodiment, the sports target system 100 may comprise at least one actuator 106, wherein the number of actuators 106 in the at least one actuator 106 is equal to the number of target subsystems 102 of the at least one target subsystem 102. In this embodiment, the push bar subsystem 108 further comprises at least one push rod 116 and at least one actuator connector 118. The number push rods 116 and the number of actuator connector 108 is equal to the number of actuators 106 of the at least one actuator 106. In use, each target subsystem 102 is configured to be individually and separately reset wirelessly by a user.

In an exemplary embodiment, the sports target system 100 may be configured to individually reset each target subsystem 102 of the at least one target subsystem 102, via each corresponding at least one actuator 106. In another exemplary embodiment, the sports target system 106 may be configured to activate all actuators 106 of the at least one actuator 106 so as to reset each target subsystem 102 of the at least one target subsystem 102 simultaneously. In yet another exemplary embodiment, the sports target system 100 may be configured to randomize the order that each actuator 106 of the at least one actuator 106 resets the corresponding target subsystem 102, so as to present a randomized order of targets to the user for an increased skill challenge. In this particular embodiment, in use, the at least one target subsystem 102 may be configured to start in the horizontal position. Upon activation of the user, the actuators 106 of the at least one actuator 106 may be configured to successively rotate the corresponding target subsystem 102 of the at least one target subsystem 102 from the horizontal position to the upright position with a predetermined or variable time delay between successive rotations. Each time the sports target system 100 is activated in this embodiment, the order of the actuators 106 of the at least one actuator 106 may be configured to be different. In an exemplary embodiment, the sports target system 100 may be reset via a wired controller, via a wireless remote, and/or wirelessly via a mobile application on a personal electronic device (such as a cellular phone or tablet).

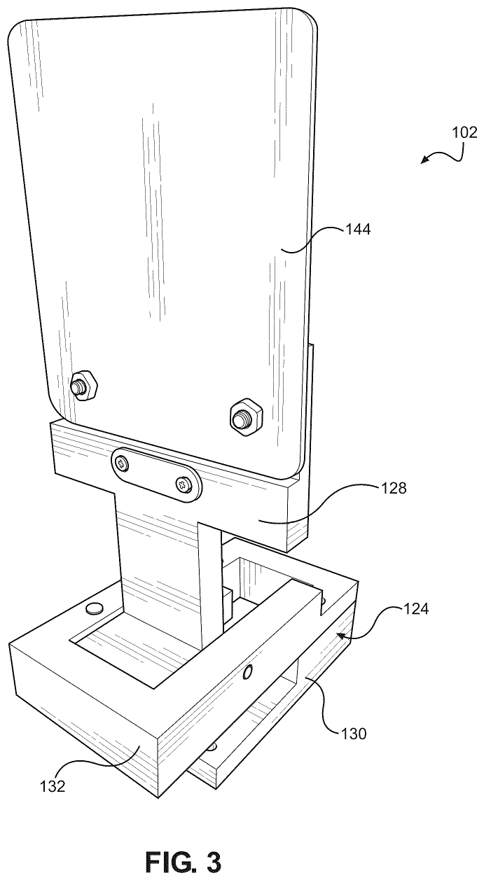

Referring now to FIGS. 3-6, the sports target system 100 further comprises the at least one target subsystem 102. In an exemplary embodiment, the at least one target subsystem 102 may comprise one target subsystem 102, two target subsystems 102, or n target subsystems 102. In a preferred embodiment, the at least one target subsystem 102 comprises six target subsystems 102. Each target subsystem 102 of the at least one target subsystem 102 comprises a mount 124, a crank 126, and a target holder 128.

In an exemplary embodiment, the mount 124 is configured to be fixedly secured to the top surface of the base case section 112. The mount comprises a lower mount segment 130, configured to be fixedly secured to the base case section 112, and an upper mount segment 132, configured to support the target holder 128. In an exemplary embodiment, the lower mount segment 130 and the upper mount segment 132 are integrally and monolithically connected. In another exemplary embodiment, the lower mount segment 130 and the upper mount segment 132 are separate elements secured together via a fastening means. In an exemplary embodiment, at least a portion of the upper mount segment 132 is spaced vertically apart from at least a portion of the lower mounts segment 130 to define a crank gap 134. The crank 126 is configured to be supported within the crank gap 134. In an exemplary embodiment, the crank 126 is configured to be rotatably connected to the mount 124. In an exemplary embodiment, the axis of rotation of the crank 126 is configured to be substantially orthogonal to the longitudinal axis 114 in the vertical direction.

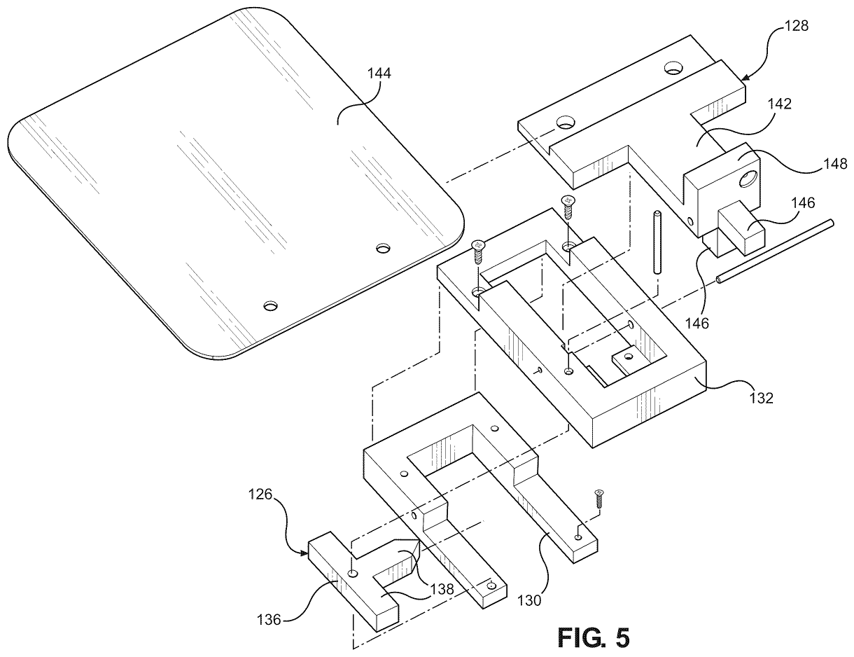

Referring now specifically to FIG. 5, in an exemplary embodiment, the crank 126 comprises a push block engagement surface 136 and at least one target holder engagement arm 138. The push block engagement surface 136 is configured to be in a substantially vertical plane and is configured to engage the steps 122 of the at least one push block 120 when the actuator 106 extends. The at least one target holder engagement arm 138 is configured to engage the target holder 128, when the crank 126 is rotated by extension of the actuator 106, such as to cause rotation of the target holder 128. In an exemplary embodiment, the at least one target subsystem 102 may further comprise a resilient member 140 connected to the crank 126 at a first end and to the mount 124 at a second end. The resilient member 140 may be configured to provide a restorative rotational force to the crank 126 to return the crank 126 to its original position after being rotated by extension of the actuator 106. In an exemplary embodiment, the resilient member 140 may comprise a helical spring, a leaf spring, an elastic band, and/or any other suitable resilient member.

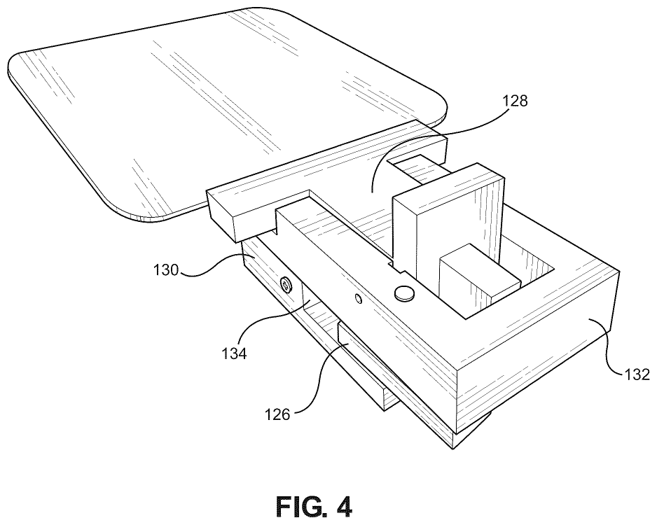

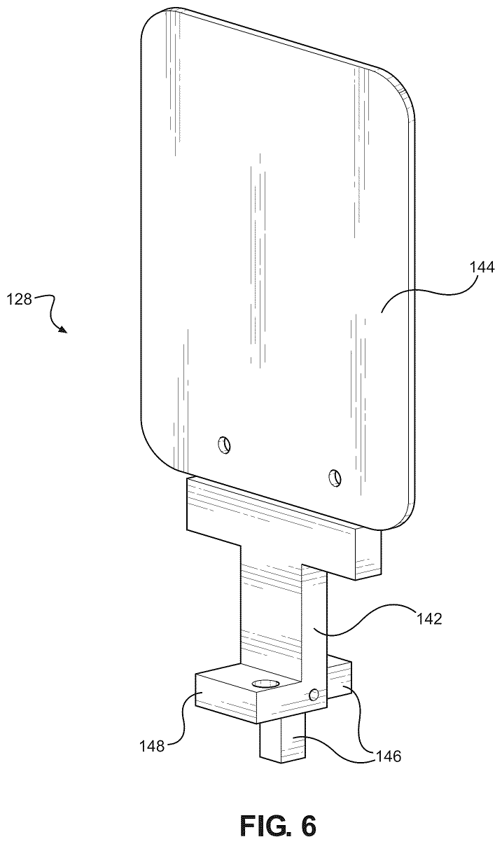

Referring now specifically to FIG. 6, in an exemplary embodiment, the target holder 128 comprises a holder body 142, a target plate 144, at least one lever arm 146, and a magnet holder 148. The holder body 142 is configured to be rotatably secured to the upper mount segment 132 of the mount 124, such that an axis of rotation of the holder body 142 is substantially parallel to the longitudinal axis 114. In an exemplary embodiment, the target holder 128 is configured to be rotatable between an upright position (see FIG. 3) and a horizontal position (see FIG. 4). In an exemplary embodiment, the holder body 142 is configured to selectively secure a target plate 144 through use of screws, bolts, or any other suitable reversible fastening means. In an exemplary embodiment, target plate 144 is configured to be replaceable with another target plate 144. In an exemplary embodiment, the at least one lever arm 146 is configured to extend outwards from holder body 142. The at least one lever arm 146 is configured to contact the at least one target holder engagement arm 138 of the crank 126 when the crank 126 rotates. In a preferred embodiment, the at least one lever arm 146 comprises two lever arms 146 disposed substantially orthogonal to each other. In an exemplary embodiment, the target holder 128 is configured to include a magnet holder 148 which supports one or more magnets/magnetic materials (not shown). When the target holder 128 is in the upright position (FIG. 3), the magnets/magnetic materials in the magnet holder 148 are configured to engage a corresponding one or more magnets/magnetic materials (not shown) in the mount 124, such that the target holder 128 is maintained in the upright position.

In use, the sports target system 100 is set up with each target holder 128 of the at least one target subsystem 102 in the upright position. The user strikes the target plate 144 of the at least one target subsystem 102 with a projectile (e.g., airsoft pellet, bullet, etc.) which rotates the target holder 128 from the upright position (FIG. 3) to the horizontal position (FIG. 4). When the user desires to reset the at least one target subsystem 102 to the upright position, the user activates the actuator 106. The actuator 106 extends and translates the push rod 116 along the longitudinal axis 114. The at least one push block 120, when translated by the actuator 106, comes into engagement with the push block contact surface 136 of the crank 126, thereby causing rotation of the crank 126. The rotation of the crank 126 causes the at least one target holder engagement arm 138 to engage the at least one lever arm 146 of the target holder 128. As the at least one lever arm 146 is rotated by the crank 126, the target holder 128 rotates from the horizontal position back to the upright position.

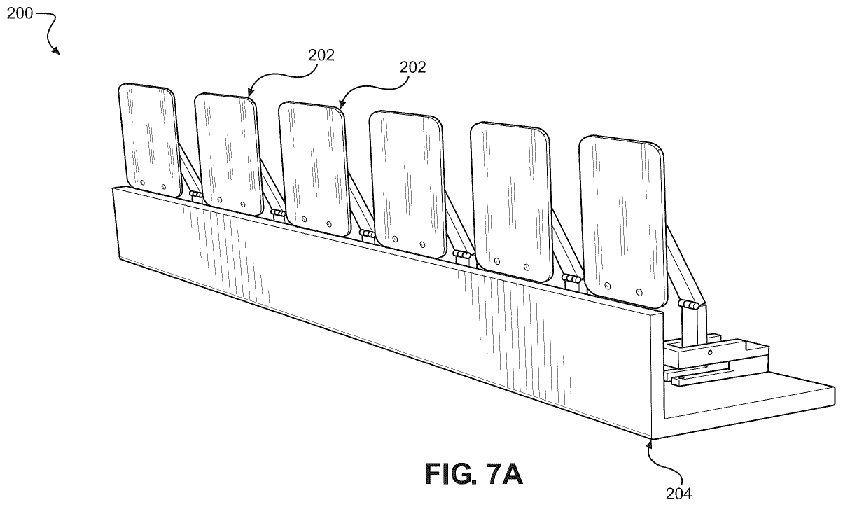

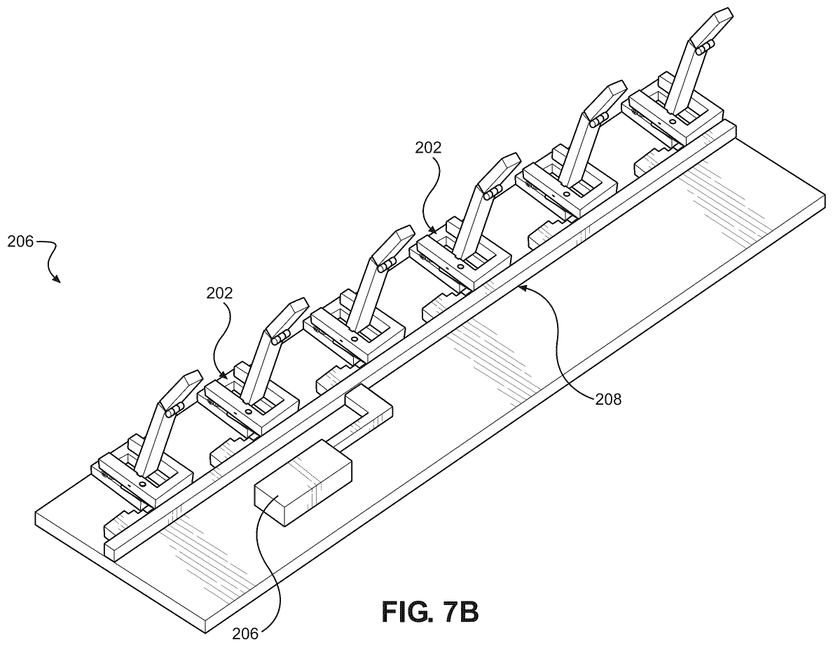

Referring now to FIGS. 7A-7B, a sports target system 200 according to a second embodiment of the present invention is illustrated, with like components given like reference numerals. The sports target system 200 comprises at least one target subsystem 202 secured to a case 204, an actuator 206 secured to the case 204, and a push bar subsystem 208 connected to the actuator and the at least one target subsystem 202. In this embodiment, the case 204, the actuator 206, and the push bar subsystem 208 are substantially similar to the case 104, the actuator 106, and the push bar subsystem 108 of the sports target system 100.

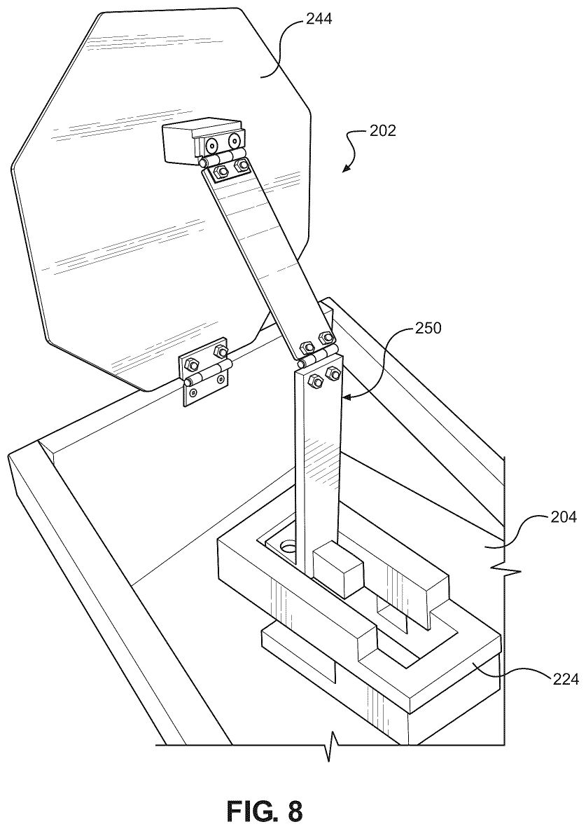

Referring now to FIG. 8, the sports target system 200 comprises the at least one target subsystem 200. In an exemplary embodiment, the at least one target subsystem 202 may comprise one target subsystem 202, two target subsystems 202, or n target subsystems 202. In a preferred embodiment, the at least one target subsystem 202 comprises six target subsystems 202. Each target subsystem 202 of the at least one target subsystem 202 comprises a mount 224, a crank 226, and a holder arm assembly 250.

In an exemplary embodiment, the mount 224 is configured to be fixedly secured to the top surface of the case 204, and is substantially similar to mount 124. Similarly, in an exemplary embodiment, crank 226 is rotatably connected to the mount 224, and is substantially similar to crank 126. In an exemplary embodiment, the axis of rotation of the crank 226 is configured to be substantially orthogonal to the longitudinal axis 214 in the vertical direction.

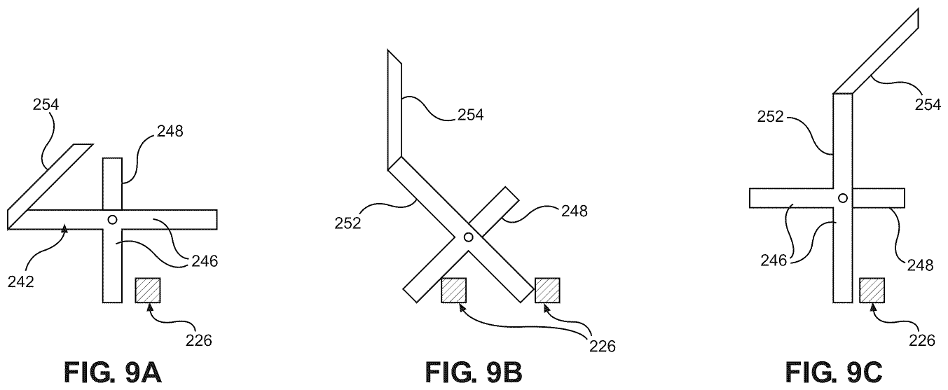

Referring now to FIGS. 9A-9C, in an exemplary embodiment, the holder arm assembly 250 comprises a holder body 242 including a lower linkage 252, a target plate 244, at least one lever arm 246, a magnet holder 248, and an upper linkage 254. The holder body 242 is configured to be rotatably secured to the mount 224, such that an axis of rotation of the holder body 242 is substantially parallel to the longitudinal axis 214. In an exemplary embodiment, the holder arm assembly 250 is configured to be rotatable between an upright position (see FIG. 9C) and a horizontal position (see FIG. 9A). In an exemplary embodiment, the at least one lever arm 246 is configured to extend outwards from holder body 242. The at least one lever arm 246 is configured to contact the crank 226 when the crank 226 rotates. In a preferred embodiment, the at least one lever arm 246 comprises two lever arms 246 disposed substantially orthogonal to each other. In an exemplary embodiment, the holder arm assembly 250 is configured to include a magnet holder 248 which supports one or more magnets/magnetic materials (not shown). When the target holder 228 is in the upright position (FIG. 9C), the magnets/magnetic materials in the magnet holder 248 are configured to engage a corresponding one or more magnets/magnetic materials (not shown) in the mount 224, such that the holder arm assembly 250 is maintained in the upright position.

In an exemplary embodiment, the holder body 242 includes the lower linkage 252 extending therefrom. In the upright position, the lower linkage 252 is configured to extend vertically upward from the holder body 242. In an exemplary embodiment, the upper linkage 254 is configured to hingedly connect to the lower linkage 252 at a first end, and to hingedly connect to the target plate 244 at a second end. In an exemplary embodiment, the target plate 244 is hingedly secured to a top edge of a front of the case 204, such that an axis of rotation of the target plate 244 is parallel to the longitudinal axis 214 and parallel to the axis of rotation of the holder body 242.

In use, the sports target system 200 is set up with each holder arm assembly 250 of the at least one target subsystem 202 in the upright position. A user strikes the target plate 244 of the at least one target subsystem 202 with a projectile (e.g., airsoft pellet, bullet, etc.) which rotates the holder arm assembly 250 from the upright position (FIG. 9C) to the horizontal position (FIG. 9A). When the user desires to reset the at least one target subsystem 202 to the upright position, the user activates the actuator 206. The actuator 206 extends and translates the push rod 216 along the longitudinal axis 214. The at least one push block 220, when translated by the actuator 206, comes into engagement with the crank 226, thereby causing rotation of the crank 226. The rotation of the crank 226 causes the push block 220 to engage the at least one lever arm 246 of the holder arm assembly 250. As the at least one lever arm 246 is rotated by the crank 226, the holder arm assembly 250 rotates from the horizontal position back to the upright position.

Those skilled in the art will recognize improvements and modifications to the preferred embodiments of the present disclosure. All such improvements and modifications are considered within the scope of the concepts disclosed herein and the claims that follow.

What is claimed is:

1. A sports target system, comprising:
a case defining a longitudinal axis;
at least one target subsystem secured to the case, each target subsystem of the at least one target subsystem comprising a mount secured to the case, a target holder, and a crank, the target holder and the crank each being rotatably secured to the mount, wherein the target holder is rotatable between an upright position and a horizontal position; and
at least one actuator secured to the base and configured to translate a push bar subsystem;
wherein:
when the actuator translates the push bar subsystem, the push bar subsystem is configured to engage each crank of the at least one target subsystem and cause rotation thereof, and
for each target subsystem, rotation of the crank is configured to rotate the target holder from the horizontal position to the upright position.

2. The sports target system of claim 1, wherein the at least one target subsystem comprises six target subsystems.

3. The sports target system of claim 1, wherein the case comprises a lower case section and an upper case section, the lower case section and the upper case section being orthogonal.

4. The sports target system of claim 3, wherein each crank of the at least one target subsystem is configured to rotate in a plane parallel to the lower case section.

5. The sports target system of claim 1, wherein an axis of rotation of each crank is orthogonal to the longitudinal axis.

6. The sports target system of claim 1, wherein the target holder further comprises at least one lever arm configured to engage the crank.

7. The sports target system of claim 6, wherein the crank further comprises at least one target holder engagement arm configured to engage the at least one lever arm.

8. The sports target system of claim 1, wherein:
the target holder further comprises one or more magnets in a magnet holder, and the mount further comprises one or more magnets, and
the one or more magnets of the target holder are configured to engage the one or more magnets of the mount when the target holder is in the upright position.

9. The sports target system of claim 1, wherein the push bar subsystem further comprises a push rod and at least one push block.

10. The sports target system of claim 9, wherein a number of push blocks in the at least one push block is equal to the number of target subsystems in the at least one target subsystem.

11. The sports target system of claim 9, wherein the at least one push block comprises six push blocks.

12. A sports target system, comprising:
a case defining a longitudinal axis and comprising a lower case section and an upper case section, the lower case section and the upper case section being orthogonal;
at least one target subsystem secured to the case, each target subsystem of the at least one target subsystem comprising a mount secured to the case, a holder arm assembly, and a crank, the holder arm assembly and the crank each being rotatably secured to the mount, wherein the holder arm assembly is rotatable between an upright position and a horizontal position; and
at least one actuator secured to the base and configured to translate a push bar subsystem;
wherein:
the holder arm assembly comprises a holder body rotatably secured to the mount, a lower linkage extending from the holder body, an upper linkage hingedly secured to the lower linkage at a first end and hingedly secured to a target plate at a second end, and the target plate hingedly secured to the upper case section,
when the actuator translates the push bar subsystem, the push bar subsystem is configured to engage each crank of the at least one target subsystem and cause rotation thereof, and
for each target subsystem, rotation of the crank is configured to rotate the target holder from the horizontal position to the upright position.

13. The sports target system of claim 12, wherein the at least one target subsystem comprises six target subsystems.

14. The sports target system of claim 12, wherein each crank of the at least one target subsystem is configured to rotate in a plane parallel to the lower case section.

15. The sports target system of claim 12, wherein an axis of rotation of each crank is orthogonal to the longitudinal axis.

16. The sports target system of claim 12, wherein the holder body further comprises at least one lever arm configured to engage the crank.

17. The sports target system of claim 16, wherein the crank further comprises at least one target holder engagement arm configured to engage the at least one lever arm.

18. The sports target system of claim 12, wherein:
the holder body further comprises one or more magnets in a magnet holder, and the mount further comprises one or more magnets, and
the one or more magnets of the target holder are configured to engage the one or more magnets of the mount when the target holder is in the upright position.

19. The sports target system of claim 1, wherein the push bar subsystem further comprises a push rod and at least one push block.

20. The sports target system of claim 9, wherein a number of push blocks in the at least one push block is equal to the number of target subsystems in the at least one target subsystem.
